(19) United States
(12) Patent Application Publication
(10) Pub. No.: US 2026/0064692 A1
(43) Pub. Date: Mar. 5, 2026

(54) LOG QUERY METHOD, MEDIUM, AND ELECTRONIC DEVICE

(71) Applicant: Beijing Volcano Engine Technology Co., Ltd., Beijing (CN)

(72) Inventor: Hong ZHAO, Beijing (CN)

(21) Appl. No.: 19/238,121

(22) Filed: Jun. 13, 2025

(30) Foreign Application Priority Data
Aug. 30, 2024 (CN) 202411216796.4

(51) Int. Cl. G06F 16/2455; G06F 16/22; G06F 16/2453

(52) U.S. Cl. CPC G06F 16/24553; G06F 16/22; G06F 16/24542

(57) ABSTRACT

A log query method, a medium, and an electronic device are provided. The method includes: receiving a log query request; searching for a target time index in a target time index file and a target log storage file from a time index file constructed based on a log and a log storage file, respectively, and searching for a target query range corresponding to the target time index from the target log storage file; constructing a query plan according to the target query range; and according to the query plan, controlling a worker node to search in parallel for a data segment index matching with a data block specified by an assigned query sub-task from a data segment index file corresponding to the target log storage file, and querying a target log content based on a target data block corresponding to the data segment index.

### CROSS-CITATION TO RELATED APPLICATION

The present application claims priority to Chinese Patent Application No. 202411216796.4 filed on Aug. 30, 2024. The aforementioned Chinese patent application is hereby incorporated by reference in its entirety as part of the present application.

### TECHNICAL FIELD

The present disclosure relates to the field of log query, and in particular, to a log query method, an apparatus, a medium, an electronic device and a program product.

### BACKGROUND

At present, in a scenario of massive log data, a log search engine usually accelerates a retrieval process by establishing an index. A currently very popular log search engine performs word segmentation and processing on a document content during a data writing process, and constructs an inverted index. However, this manner requires a relatively large storage space to store index information, and as the amount of data increases, the storage cost required for the index also becomes higher and higher.

Therefore, how to provide a low-cost and efficient log search engine, greatly reduce the storage cost caused by the index, and improve the performance of the log retrieval as much as possible on the basis of low cost, and meet more usage scenarios of log retrieval, is currently a technical problem that needs to be solved urgently.

### SUMMARY

The summary is provided to introduce concepts in a simplified form, and these concepts will be described in detail in the following specific embodiments. This summary is not intended to identify key features or necessary features of the claimed technical solution, nor is it intended to be used to limit the scope of the claimed technical solution.

In a first aspect, the present disclosure provides a log query method, comprising: receiving a log query request, where the log query request is used to request to query a target log content within a target time range; in response to the log query request, separately searching for a target time index in a target time index file corresponding to the target time range and a target log storage file from a time index file constructed based on a log and a log storage file, and searching for a target query range corresponding to the target time index from the target log storage file, where the time index file is dynamically constructed based on time in the log and is in a one-to-one correspondence with the log storage file; constructing a query plan according to the target query range, where the query plan is used to indicate a query sub-task corresponding to a data block into which the target query range is divided; and according to the query plan, controlling a worker node to search for a data segment index matching a data block specified by an assigned query sub-task from a data segment index file corresponding to the target log storage file in parallel, and querying the target log content based on a target data block corresponding to the data segment index, where the data segment index file is dynamically constructed based on a data segment into which the log in the log storage file is divided.

In a second aspect, the present disclosure provides a log query apparatus, comprising: a receiving module, configured to receive a log query request, where the log query request is used to request to query a target log content within a target time range; and a log query module, configured to: in response to the log query request, search for a target time index in a target time index file corresponding to the target time range and a target log storage file from a time index file constructed based on a log and a log storage file, respectively, and search for a target query range corresponding to the target time index from the target log storage file, where the time index file is dynamically constructed based on time in the log and is in a one-to-one correspondence with the log storage file; construct a query plan according to the target query range, where the query plan is used to indicate a query sub-task corresponding to a data block into which the target query range is divided; and according to the query plan, control a worker node to search in parallel for a data segment index matching a data block specified by an assigned query sub-task from a data segment index file corresponding to the target log storage file, and query the target log content based on a target data block corresponding to the data segment index, where the data segment index file is dynamically constructed based on a data segment into which the log in the log storage file is divided.

In a third aspect, the present disclosure provides a computer-readable medium, on which a computer program is stored, where the computer program, when executed by at least one processor, implements the steps of the method according to any one of the first aspect.

In a fourth aspect, the present disclosure provides an electronic device, comprising:
a memory, on which a computer program is stored; and
at least one processor, configured to execute the computer program in the memory to implement the steps of the method according to any one of the first aspect.

In a fifth aspect, the present disclosure provides a computer program product, comprising a computer program, where the computer program, when executed by a processor, implements the steps of the method according to any one of the first aspect.

Other features and advantages of the present disclosure will be described in detail in the following specific implementations.

### BRIEF DESCRIPTION OF DRAWINGS

The above and other features, advantages, and aspects of the embodiments of the present disclosure will become more apparent when taken in conjunction with the drawings and with reference to the following specific implementations. Throughout the drawings, the same or similar reference numerals represent the same or similar elements. It should be understood that the drawings are schematic and that parts and elements are not necessarily drawn to scale. In the drawings:

FIG. 1 is a schematic diagram of a log index structure according to the related art.

FIG. 2 is a schematic structural diagram of a time index file according to an embodiment of the present disclosure.

FIG. 3 is a schematic diagram of merging generated time indexes according to an embodiment of the present disclosure.

FIG. 4 is a schematic structural diagram of a data segment index file according to an embodiment of the present disclosure.

FIG. 5 is a schematic diagram of a shared prefix tree according to an embodiment of the present disclosure.

FIG. 6 is a schematic diagram of merging generated data segment indexes according to an embodiment of the present disclosure.

FIG. 7 is a flowchart of a log query method according to an embodiment of the present disclosure.

FIG. 8 is a schematic diagram of merging target time indexes according to an embodiment of the present disclosure.

FIG. 9 is a schematic diagram of parsing a structured log according to an embodiment of the present disclosure.

FIG. 10 is a schematic diagram of an overall architecture of log query according to an embodiment of the present disclosure.

FIG. 11 is a schematic block diagram of a log query apparatus according to an embodiment of the present disclosure.

FIG. 12 shows a schematic structural diagram of an electronic device suitable for implementing the embodiments of the present disclosure.

### DETAILED DESCRIPTION

The embodiments of the present disclosure will be described in more detail below with reference to the drawings. Although some embodiments of the present disclosure are shown in the drawings, it should be understood that the present disclosure may be implemented in various forms and should not be construed as limited to the embodiments set forth herein. On the contrary, these embodiments are provided for a more thorough and complete understanding of the present disclosure. It should be understood that the drawings and embodiments of the present disclosure are only for illustrative purposes, and are not intended to limit the scope of protection of the present disclosure.

It should be understood that the various steps described in the method implementations of the present disclosure may be performed in a different order, and/or in parallel. In addition, the method implementations may comprise additional steps and/or omit to perform the illustrated steps. The scope of the present disclosure is not limited in this respect.

The term “comprise/comprise” and its variants as used herein are open-ended inclusions, that is, “comprise/comprise but not limited to”. The term “based on” is “based at least in part on”. The term “one embodiment” means “at least one embodiment”; the term “another embodiment” means “at least one additional embodiment”; and the term “some embodiments” means “at least some embodiments”. Relevant definitions of other terms will be given in the description below.

It should be noted that concepts such as “first” and “second” mentioned in the present disclosure are only used to distinguish between different apparatuses, modules or units, and are not used to limit the order of functions performed by these apparatuses, modules or units or their interdependence.

It should be noted that the modifications of “one” and “a plurality of” mentioned in the present disclosure are illustrative rather than restrictive, and those skilled in the art should understand that they should be construed as “one or more” unless the context clearly indicates otherwise.

The names of messages or information exchanged between a plurality of apparatuses in the implementations of the present disclosure are only used for illustrative purposes, and are not intended to limit the scope of these messages or information.

Before describing the log query method according to the embodiments of the present disclosure in detail, the log index structure according to the embodiments of the present disclosure will be described first.

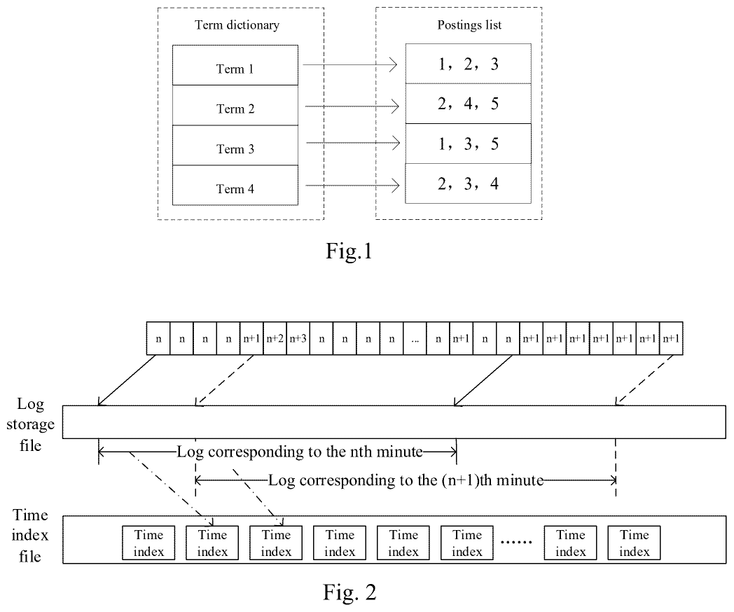

The log index can accelerate the log query process. In the related art, a common elasticsearch (ES) engine performs word segmentation and processing on log document content, and constructs an inverted index as a log index. The inverted index is a structure that uses words in the document content as indexes and uses document IDs containing the words as records. This structure usually needs to comprise two parts of data. As shown in FIG. 1, the first part of data is a term dictionary, which consists of a series of terms generated after word segmentation of the content in the document; and the second part of data is a posting list, which contains information such as document IDs. When querying the log, relevant words are found in the term dictionary first, and then corresponding posting lists are obtained. Detailed information in the log document is obtained according to information such as document IDs in the posting list.

The above log index structure will bring additional storage cost. For example, under the general configuration of ES, the expansion ratio of the index to the original log data is about 0.8 to 1.3. In other words, assuming that the amount of original log data is 1 TB, the log index needs about 0.8 TB to 1.3 TB storage space. The larger the amount of original log data, the higher the storage cost of the log index will be.

The log index structure according to the embodiments of the present disclosure comprises a time index file and a data segment index file, which are used to index an original log storage file from a time dimension and a data segment dimension, respectively. The time index file and the log storage file are in a one-to-one correspondence. The log storage file and the data segment index file may be in a one-to-many relationship, or may be in a one-to-one correspondence.

The log storage file is used to store the log, and may be obtained in the following manner.

The log storage file may be a log storage file obtained according to a preset time granularity of log storage. Hereinafter, the preset time granularity of log storage is represented by a first time granularity. When generating the log storage file, the log may be written into different log storage files according to the first time granularity.

The first time granularity may be 1 hour, 1 day, etc., which is not limited in the present disclosure.

For the log in each first time granularity, the log in the first time granularity may be written into one or more log storage files corresponding to the first time granularity according to a preset storage amount of a single log storage file corresponding to the first time granularity and an amount of the log data in the first time granularity. That is, if the amount of the log data in the first time granularity is less than or equal to the preset storage amount of the single log storage file corresponding to the first time granularity, the log in the first time granularity is written into one log storage file corresponding to the first time granularity; and if the amount of the log data in the first time granularity is greater than the preset storage amount of the single log storage file corresponding to the first time granularity, the log in the first time granularity is written into a plurality of log storage files corresponding to the first time granularity, respectively. The preset storage amount of the log storage file may be a preset number of stored logs or a preset storage space occupation (for example, in bytes). The amount of the log data in the first time granularity may be a total number of logs in the first time granularity or an amount of storage space occupied by the logs in the first time granularity (for example, in bytes).

Each first time granularity may be identified by a corresponding first time granularity identification (DataTime). The log storage file corresponding to each first time granularity may be identified by a first time granularity identification of the first time granularity plus a file identification (hpathid) of the log storage file, that is, for example, identified by “[DataTime]-[hpathid]”. Exemplarily, the log storage file may be identified by including “[DataTime]-[hpathid]” in a file name of the log storage file.

Taking the first time granularity of 1 hour as an example, for each first time granularity, the logs belonging to different hours may be written into the log storage file corresponding to the corresponding hour. For example, the logs within the hour from 10:00 to 11:00 on Jun. 18, 2024 are written into two log storage files, and the first time granularity identification of this hour may be 2024061810. The file identification of the first log storage file in the two log storage files may be 1, and the file identification of the second log storage file may be 2. Then, the first log storage file may be identified by “2024061810-1”, and the second log storage file may be identified by “2024061810-2”.

The time index file comprises a plurality of time indexes. The time index file and the time index are used to index the log storage file from the time dimension. The time index file and the time index comprised in the time index file may be obtained in the following manner.

For each log storage file, the log of the time granularity may be acquired from the log storage file and parsed to obtain the time and storage address of the log of the time granularity according to a preset time granularity of the time index, and then a corresponding time index is generated according to the information of the storage address of the log of the time granularity and a time identification (TimeID) of the log of the time granularity determined based on the time granularity, and the time index is written into the time index file in sequence to obtain the time index file for the log storage file. The time index is in a one-to-one correspondence with the log of the time granularity, and the time index file is in a one-to-one correspondence with the log storage file. The preset time granularity of the time index is less than the preset time granularity of the log storage.

Hereinafter, the preset time granularity of the time index is represented by a second time granularity.

For each time index, the time index may comprise a storage address of the log corresponding to the time index in the log storage file and a time identification of the log corresponding to the time index.

The time index may be a sparse time index. The time index is constructed based on the time in the log, and is intended to determine the log query range through the time index in the subsequent log query process.

The size of the second time granularity is configurable, and may be, for example, 1 second, 1 minute, or other sizes. The first time granularity may comprise a plurality of second time granularities.

For each time index, the storage address of the log corresponding to the time index in the log storage file may comprise a start position (startPos) and an end position (endPos) of the log corresponding to the time index in the log storage file, or may comprise offset information (offset) of the log corresponding to the time index in the log storage file and a length of the log corresponding to the time index. The offset information of the log corresponding to the time index in the log storage file refers to an offset of the log corresponding to the time index relative to the start position of the log storage file.

For each second time granularity, the time identification of the second time granularity is used to indicate which second time granularity in the first time granularity to which the second time granularity belongs the second time granularity corresponds to. For example, if the first time granularity is 1 hour and the second time granularity is 1 minute, the time identification of the second time granularity is used to indicate which minute in the first time granularity to which the second time granularity belongs the second time granularity corresponds to, and the value range of the time identification of the second time granularity may be 0 to 59.

In addition to the information of the storage address and the time identification information, the time index may further comprise other metadata information, for example, containing finer log classification information for logs, and the like.

The time index file corresponding to the log storage file may be identified by a first time granularity identification (DataTime) of the first time granularity corresponding to the log storage file plus a file identification (hpathid) of the log storage file, that is, for example, identified by “[DataTime]-[hpathid]”, so that the time index file and the log storage file are in a one-to-one correspondence, which facilitates quick location in the subsequent log query process. Exemplarily, the log index file may be identified by including “[DataTime]-[hpathid]” in the file name of the log index file.

The time index may be stored in the corresponding time index file in various manners, for example, may be stored in an inverted index format.

FIG. 2 is a schematic structural diagram of a time index file according to an embodiment of the present disclosure. In FIG. 2, the first time granularity is 1 hour, and the second time granularity is 1 minute. As shown in FIG. 2, the logs corresponding to different minutes are indexed with different time indexes.

Further, due to reasons such as out-of-order log time (for example, in FIG. 2, there is an out-of-order log time between the log in the nth minute and the log in the (n+1)th minute), there may be time overlap and log range overlap between the generated time indexes. Therefore, it is necessary to further merge the generated time indexes to reduce the number of time indexes and further reduce the storage cost of the log index. Therefore, if the time identifications of the two generated time indexes are the same and the interval between the log storage addresses corresponding to the two time indexes is less than a preset merge length threshold (MaxMergeLength), the two time indexes are merged into one time index and updated to the time index file. In this way, one or a small number of read Input/Output Operations Per Second (IOPS) can be used to load adjacent log ranges together in the subsequent log query process, reducing the pressure of read IOPS. If the time identifications of the two generated time indexes are the same and the interval between the log storage addresses corresponding to the two time indexes is greater than or equal to the preset merge length threshold, the two time indexes are not merged. In this way, some unnecessary log data can be skipped as much as possible in the subsequent log query process, and the efficiency of the log query is improved.

The preset merge length threshold is configurable, and may be, for example, 4 MB.

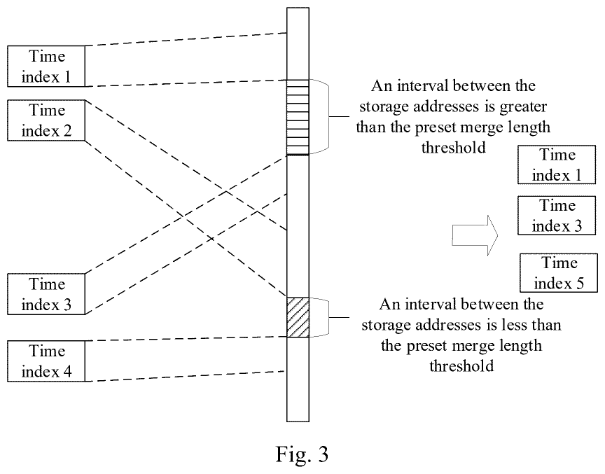

FIG. 3 is a schematic diagram of merging generated time indexes according to an embodiment of the present disclosure. As shown in FIG. 3, the generated time index 1 and the generated time index 3 have the same time identification, and the generated time index 2 and the generated time index 4 have the same time identification. The vertical rectangle in FIG. 3 is used to represent the storage address of the log corresponding to the time index in the log storage file. Since the interval between the storage addresses indicated by the generated time index 1 and the generated time index 3 is greater than the preset merge length threshold, the generated time index 1 and the generated time index 3 are not merged. Since the interval between the storage addresses indicated by the generated time index 2 and the generated time index 4 is less than the preset merge length threshold, the generated time index 2 and the generated time index 4 are merged into the time index 5. Therefore, the time indexes obtained after merging comprise the time index 1, the time index 3, and the time index 5.

In an actual production environment, the time of the vast majority of logs is basically in order, and the time deviation between adjacent logs will not be very large. Therefore, after the time index is generated for the first time, each second time granularity generally comprises only one or a small number of time indexes. If the out-of-order log time is relatively serious, the logs in the same second time granularity are distributed at different positions in the log storage file. In this case, after the time index is generated for the first time, the same second time granularity may correspond to a plurality of time indexes, resulting in a larger storage space occupied by the log index. Through continuous merging of time indexes, the number of time indexes can be greatly reduced, and the storage cost of the log index can be reduced.

The data segment index file and the data segment index (DataRecord) comprised in the data segment index file are used to index the log storage file from a dimension of the data segment. The data segment index file and the data segment index comprised in the data segment index file may be obtained in the following manner.

For each log storage file, the log may be acquired from the log storage file and divided into a plurality of data segments according to a preset data segment division granularity, where each data segment comprises a plurality of logs; for each data segment, the data segment is parsed to obtain a key-value pair and a log storage address of each log; and for each data segment, one data segment index is generated for a key of each log in the data segment, and the data segment index is written into a corresponding data segment index file in a generation order, where the data segment index at least indicates a position of the corresponding data segment in the corresponding log storage file.

The log storage file may be divided into a plurality of data segments according to a variety of division rules. For example, the division may be performed according to a preset data segment size (SegmentSplitSize), or the division may be performed according to a preset number of logs. The preset data segment size is configurable, and may be, for example, 10 MB or other sizes. The preset number of logs is also configurable.

Each data segment comprises a plurality of complete logs. That is, each data segment needs to comprise a plurality of complete logs, and the size of each data segment may be different, and the division may be as uniform as possible.

For each data segment, when the data segment index of the data segment is generated, a corresponding data segment index may be generated for each key comprised in the data segment, or a corresponding data segment index may be generated for some keys comprised in the data segment according to actual requirements. For example, if the number of keys comprised in a data segment is 3, corresponding data segment indexes may be generated for the 3 keys, respectively. The selection of keys for which the data segment index needs to be generated may be preset, user-defined, etc., or some keys may be intelligently selected to generate corresponding data segment indexes by using a certain model through artificial intelligence (AI).

Data segment indexes of different keys may be stored and managed in different data segment index files. For example, assuming that a log storage file is divided into a first data segment, a second data segment, and a third data segment, data segment indexes are generated for keys k1 and k2 comprised in the first data segment, respectively, data segment indexes are generated for keys k2 and k3 comprised in the second data segment, respectively, and data segment indexes are generated for keys k1 and k3 comprised in the third data segment, respectively, for the log storage file, there are finally 3 data segment index files, which are a data segment index file storing the data segment index of the key k1, a data segment index file storing the data segment index of the key k2, and a data segment index file storing the data segment index of the key k3. In this way, data segment indexes of different keys are stored in different data segment index files.

The data segment index of each key may be stored in the corresponding data segment index file in, for example, a column storage format (for example, ORC format).

For each data segment index file, the data segment index file may be identified by a first time granularity identification (DataTime) of the first time granularity corresponding to the log storage file corresponding to the data segment index file, a file identification (hpathid) of the log storage file corresponding to the data segment index file, and a key identification (KeyID) of the key corresponding to the data segment index file, that is, for example, identified by “[KeyID]-[DataTime]-[hpathid]”, so that the data segment index file, the log storage file, and the key are in a corresponding relationship, which facilitates quick location in the subsequent log query process. Exemplarily, the data segment index file may be identified by including “[KeyID]-[DataTime]-[hpathid]” in the file name of the data segment index file.

The data segment index file may be a sparse index file.

The data segment index file and the time index file may be generated in parallel to improve the generation efficiency of the log index. In the subsequent log query process, the log range that needs to be queried within the target time range requested by the log query request may be preliminarily determined through the time index file, and then the log query range may be further narrowed through the data segment index file, thereby speeding up the log query process.

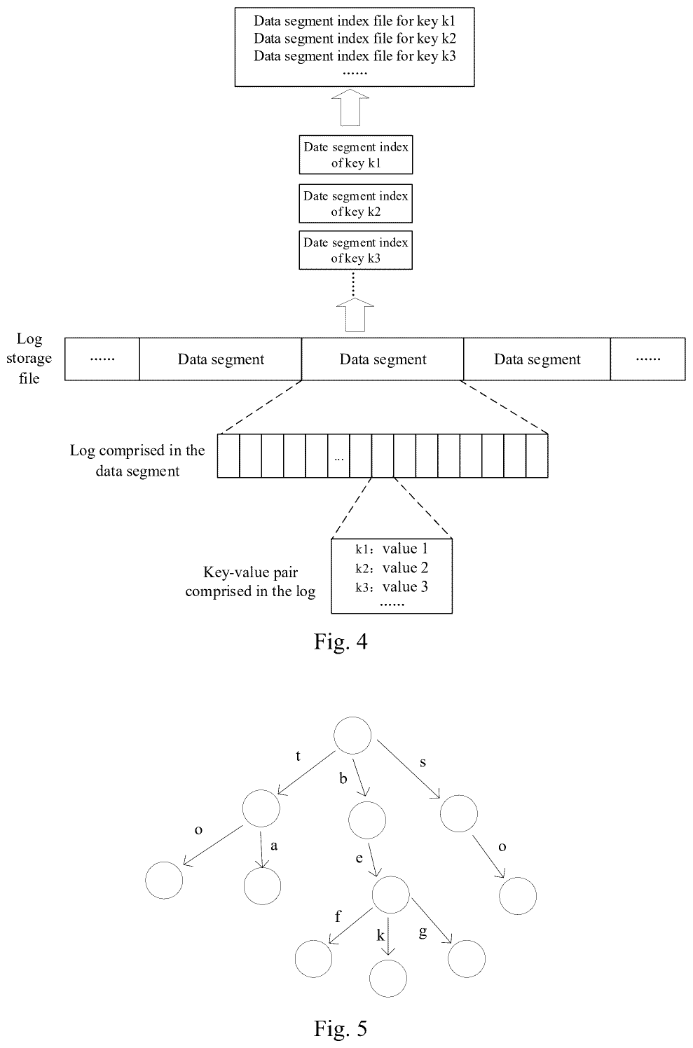

FIG. 4 is a schematic structural diagram of a data segment index file according to an embodiment of the present disclosure. As shown in FIG. 4, for each log storage file, the log storage file is first divided into several data segments, the log in each data segment is parsed to obtain key-value pair information comprised in each log, and the data segment index of the key comprised in the data segment is generated according to the key-value pair information. Then, the data segment indexes of the same key in all data segments of the log storage file are stored in the same data segment index file to obtain the data segment index file corresponding to the log storage file.

For each data segment index, the data segment index may comprise a data header (Header) field, which is used to indicate the information of the storage address of the data segment corresponding to the data segment index in the log storage file. The storage address of the data segment corresponding to the data segment index in the log storage file may comprise a start position and an end position of the corresponding data segment in the log storage file, or may comprise offset information (Offset) of the corresponding data segment in the log storage file and a length (Length) of the corresponding data segment. The offset information of the corresponding data segment in the log storage file refers to an offset of the corresponding data segment relative to the start position of the log storage file.

The data header field may further comprise at least one of the following sub-fields: a data segment index length sub-field (RecordLength), which is used to indicate a size of the data segment index; a data type sub-field (LogType), which is used to indicate a data type of the key corresponding to the data segment index in the data segment corresponding to the data segment index, for example, a string type or a long type, or the like; and a flag sub-field (Flag), which is used to indicate what metadata is comprised in the data segment index, for example, it is indicated in the Flag by relevant bits that the data segment index does not comprise a prefix tree field. The specific data type indicated by the data type sub-field may be determined by means of index configuration, etc. The index configuration may be set by the user or a preset value, or may be set according to a specific system.

For each data segment index, the data segment index may further comprise at least one of the following fields: a minimum value field (minValue), a maximum value field (maxValue), a filter field (Filter), a prefix tree field (Tier), a suffix tree field (Suffix), a number of logs field, or other metadata fields. In addition, the field sizes of these fields may be stored in the data header field.

The minimum value field is used to indicate a minimum value of the key corresponding to the data segment index in the data segment corresponding to the data segment index. The maximum value field is used to indicate a maximum value of the key corresponding to the data segment index in the data segment corresponding to the data segment index. In the subsequent log query process, some data segments that do not need to be queried can be quickly filtered out through the minimum value field and the maximum value field. For example, each log in a certain data segment comprises the key “score”, and in this data segment, the minimum value of the value corresponding to the key “score” is 60, and the maximum value is 80. Then, when the queried data is not within the range defined by the minimum value and the maximum value (for example, the target log content requested by the log query request is “score>90”), this data segment does not need to be loaded, thereby saving the read overhead and the overhead of data parsing and filtering, and improving the efficiency of the log query.

When the data segment index is generated, considering that the Key-Value (KV) in the log storage file is usually stored in a text form, when acquiring the minimum value and the maximum value of the key in the data segment, the value of the key in the text form is first converted into the data type indicated by the LogType sub-field according to the information of the LogType sub-field in the data header field, and then the maximum value and the minimum value of the key in the data segment are acquired. For example, in a certain data segment, a certain log has a key “age” with a value of “30”. According to the LogType sub-field, it is determined that the data type should be a numeric type, then the value “30” in the text form is converted into “30” in the numeric form, and then compared with values of the key “age” in other logs in the data segment, and finally the minimum value and the maximum value of the key “age” in the data segment are obtained.

The byte sizes occupied by the minimum value field and the maximum value field may be determined in the following manners:
(1) For data of a fixed-length type, for example, int32, long, or other types, the byte sizes of the minimum value field and the maximum value field may be determined according to the information in the LogType sub-field;
(2) For a variable-length data type, for example, a string type, the actual byte size of the minimum value field and the actual byte size of the maximum value field may be represented by the first several bytes (for example, 4B) of the minimum value field and the first several bytes (for example, 4B) of the maximum value field, respectively.

In addition, the minimum value field may comprise the byte size information of the minimum value field and the minimum value information of the key corresponding to the data segment index. The maximum value field may comprise the byte size information of the maximum value field and the maximum value information of the key corresponding to the data segment index.

The filter field is used to indicate all values of the key corresponding to the data segment index in the data segment corresponding to the data segment index. The filter used in the filter field may be a bloom filter. Through the bloom filter, it can be quickly determined whether an element is in a certain set. In the generation process of the data segment index, all values of the key corresponding to the data segment index in the data segment corresponding to the data segment index may be added to the bloom filter. In the subsequent log query process, some data segments that do not need to be read may be filtered out through the bloom filter, thereby improving the efficiency of the log query. For example, values corresponding to the “name” key of each log in a certain data segment are added to the bloom filter. In the subsequent log query process, if the target log content requested by the log query request is “name:xiaoming”, it can be quickly determined through the bloom filter whether “xiaoming” is possible in the data segment. If it is determined through the bloom filter that “xiaoming” is impossible in the data segment, the data segment is directly skipped.

The bloom filter in the present disclosure may be implemented by using a currently mature bloom filter, or may be developed by itself according to actual requirements.

The field size of the filter field is configurable, for example, 1 KB. The length of the filter field may be represented by the first several bytes of the filter field, which is similar to the field size representation of the variable-length maximum value field/minimum value field.

The prefix tree field is used to indicate a shared prefix tree of the values of the key corresponding to the data segment index in the data segment corresponding to the data segment index. The maximum depth M of the shared prefix tree is configurable, for example, 3. The shared prefix tree is used to share the prefix of the value of the key corresponding to the data segment index, and the storage cost is relatively low. In addition, by limiting the maximum depth of the shared prefix tree, the storage cost can be further reduced. When the shared prefix tree is generated, if the length of a certain string is greater than M, only the first M characters of the string will be added to the shared prefix tree. In the subsequent log query process, data segments may be filtered through the shared prefix tree, as shown in the shared prefix tree in FIG. 5: assuming that M is 3, and the string to be queried is “bektest”, the matching is performed from the root node of the shared prefix tree. If it is found that the prefix “bek” is shared and the matching process has reached the leaf node of the shared prefix tree, it indicates that the data segment may contain “bektest”, and further matching and filtering are required in combination with other metadata; if the data to be queried is “betest”, it is found that there is only a common prefix “be”, but the matching process does not reach the leaf node, it indicates that the data segment cannot contain the string, and the data segment may be directly skipped in the log query process.

The larger the maximum depth M of the shared prefix tree, the higher the probability of data segment filtering in the log query process, and the relatively higher the storage cost of the log index. Assuming that the size of the character set of the value of the key corresponding to the data segment index is 26, the size of the shared prefix tree is approximately 26\hat{ }M bytes in the maximum case. When M is 3, the size of the shared prefix tree is about 18 KB. In order to further reduce the storage cost of the log index, the shared prefix tree may be compressed first by a compression algorithm such as Zstandard and then stored. Assuming that the compression rate is 3, the size of the compressed shared prefix tree is approximately 6 KB.

The prefix tree field may comprise the field size information of the prefix tree field, the compression type information, and the shared prefix information, which facilitates data parsing and filtering in the subsequent log query process.

The suffix tree field is used to indicate a shared suffix tree of the values of the key corresponding to the data segment index in the data segment corresponding to the data segment index. Similar to the shared prefix tree, the shared suffix tree is used to store the common suffix of the value of the key corresponding to the data segment index. The maximum depth N of the shared suffix tree is configurable. When the shared suffix tree is generated, if the length of a certain string exceeds N, only the last N characters of the string are added to the shared suffix tree. In the subsequent log query process, the shared suffix tree may also be used to filter data segments, and the filtering process is similar to that of the shared prefix tree. In order to further reduce the storage cost of the log index, the shared suffix tree may be compressed and then stored.

The suffix tree field may comprise the field size information of the suffix tree field, the compression type information, and the shared suffix information, which facilitates data parsing and filtering in the subsequent log query process.

In the process of generating the data segment index, there may be a case where the size of the data segment corresponding to the data segment index is relatively small, for example, a scenario where the log traffic is relatively low, resulting in a relatively small amount of logs generated within a certain period of time. In this scenario, after the data segment index is generated for the first time, the adjacent data segment indexes may be merged, that is, when the amount of data in the adjacent data segments is less than a preset data segment merge threshold, the data segment indexes corresponding to the adjacent data segments are aggregated into one data segment index and the data index file is updated, so as to further reduce the storage space required by the data segment index.

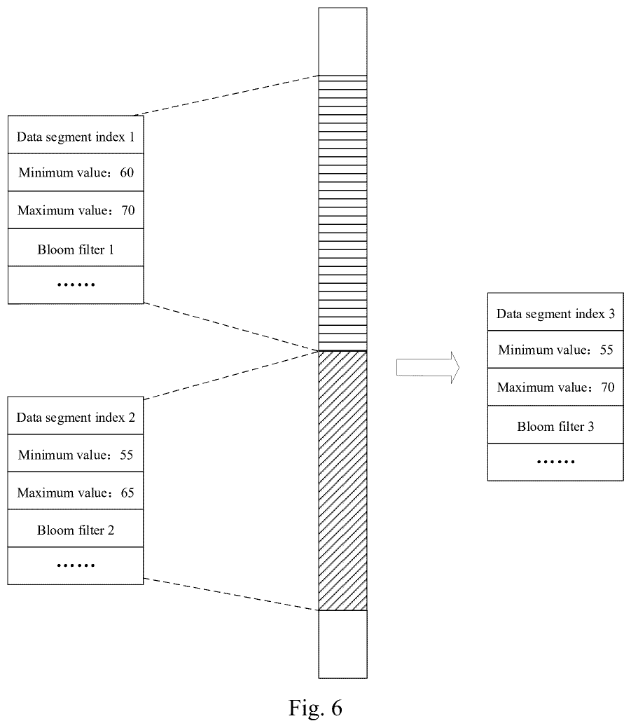

FIG. 6 is a schematic diagram of merging generated data segment indexes according to an embodiment of the present disclosure. As shown in FIG. 6, the storage address of the data segment corresponding to the generated data segment index 1 and the storage address of the data segment corresponding to the generated data segment index 2 are adjacent in the log storage file, and the size of the data segment corresponding to the generated data segment index 1 and the size of the data segment corresponding to the generated data segment index 2 are both less than the preset data segment size. Then, the generated data segment index 1 and the generated data segment index 2 may be merged into one data segment index 3, where the minimum value in the data segment index 3 is the smallest of the minimum value in the generated data segment index 1 and the minimum value in the generated data segment index 2, the maximum value in the data segment index 3 is the largest of the maximum value in the generated data segment index 1 and the maximum value in the generated data segment index 2, and the bloom filter 3 in the data segment index 3 is a combination of the bloom filter 1 in the generated data segment index 1 and the bloom filter 2 in the generated data segment index 2.

So far, the log index for log query is generated, and the generated log index comprises the time index file and the data segment index file. Since the time index file indexes the log storage file in time periods from the time dimension, and the data segment index file indexes the log storage file in data segments from the data segment dimension, there is no need to index by individual words in the log content and document IDs of the words as in the related art. Therefore, the storage cost of the log index is greatly reduced.

The storage cost of the log index according to the embodiments of the present disclosure is exemplified below.

The storage cost of the log index according to the embodiments of the present disclosure mainly comprises two parts: the first part is the storage space occupied by the time index file; and the second part is the storage space occupied by the data segment index file. The storage occupation of these two parts will be estimated separately below. The following evaluation is based on an example in which the first time granularity is 1 hour and the second time granularity is 1 minute.

In most cases, the time of adjacent logs is relatively close, and after merging the generated time indexes, in most cases, only one time index will be finally obtained per minute. Considering that there may be some abnormal situations such as time out-of-order, it is estimated that 10 time indexes are finally obtained per minute (conservative estimate), and about 14,400 time indexes will be generated every day. The fields such as start position and end position comprised in a single time index each is represented by 8B, the time identification is represented by 1B, and the size of the entire time index is estimated to be 17B. Then the time index generated in one day is less than 250 KB, and compared with the size of the original log data, the size of the time index file is almost negligible.

The size occupied by a single data segment index is not fixed. Each data segment index comprises a data header field and various metadata information, and may be estimated in the following manner:
(1) the sizes of RecordLength, Offset, and Length in the data header field are all 4B, the size of Flag is 2B, and the size of LogType is 1B;
(2) the size occupied by the minimum value field/maximum value field is related to LogType. For example, when LogType is a long data type, each minimum value field/maximum value field occupies 8B. For a variable-length type (for example, a string type), the size occupied by the minimum value field/maximum value field of a single key is not fixed. Here, it is estimated to be about 100B, and the size occupied by the minimum value field/maximum value field is about 200B;
(3) the size of the filter is also configurable, and here it is estimated to be 1 KB;
(4) the size of the prefix tree field is also not fixed, but since it is a shared prefix and the maximum depth M is limited, and the storage is performed after compression during storage, the size is relatively small. It is estimated according to a character set size of 26, and the maximum occupation of the prefix tree field in the extreme case is approximately 26\hat{ }M bytes. Here, it is estimated according to M of 3 and a compression rate of 3. The original prefix tree field occupies a maximum of 18 KB, and after compression, it can reach about 6 KB.
(5) similar to the evaluation process of the prefix tree field, the suffix tree field uses the same evaluation conditions, and occupies about 6 KB after compression.

Through the above evaluation, the size of the entire data segment index is expected to be about 14 KB. The number of keys in a data segment is estimated to be 10, and the storage occupation of the data segment index file corresponding to a data segment is about 140 KB. The size of the data segment is configured to be 10 MB here, so the expansion ratio of the data segment index file is less than 0.02, which is much lower than the index expansion ratio of ES. The overall index storage cost can be less than 2% of the original log data. According to the estimation of 1 TB original log data per day, about 1003.5 GB of log index storage space can be saved every day, and the storage cost of the log index is greatly reduced.

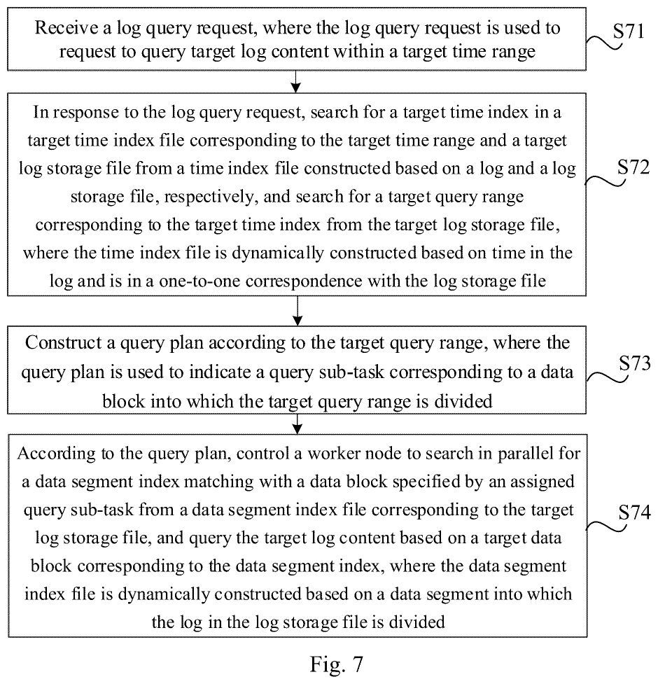

Next, the log query method according to the embodiments of the present disclosure will be described. The log query method can be applied to various log query scenarios. The log query method can use the log index described above to query the log. As shown in FIG. 7, the log query method may comprise the following steps S71 to S74.

In step S71, a log query request is received, where the log query request is used to request to query target log content within a target time range.

In step S72, in response to the log query request, a target time index in a target time index file corresponding to the target time range and a target log storage file are searched for from a time index file constructed based on a log and a log storage file, respectively, and a target query range corresponding to the target time index is searched for from the target log storage file, where the time index file is dynamically constructed based on time in the log and is in a one-to-one correspondence with the log storage file.

In order to ensure that all target time indexes within the target time range can be acquired, in step S72, before searching for the target time index, the start time and end time of the target time range need to be fine-tuned, that is, the start time of the target time range is rounded forward according to the second time granularity described above, and the end time of the target time range is rounded backward according to the second time granularity described above. For example, assuming that the start time of the target time range is “2024-06-18 15:10:53” and the end time is “2024-06-18 18:10:53”, and the second time granularity used when generating the time index is 1 minute, the start time of the target time range needs to be rounded forward to “2024-06-18 15:10:00” according to minutes, and the end time of the target time range needs to be rounded backward to “2024-06-18 18:11:00” according to minutes. The purpose of such processing is that the time index is generated according to the second time granularity, and all target time indexes within the target time range can be ensured to be acquired through rounding forward and rounding backward.

After the start time of the target time range is rounded forward according to the second time granularity and the end time of the target time range is rounded backward according to the second time granularity, the target time index and the target log storage file may be searched for in the following manners.

The target log storage file may be determined according to a matching between a file identification of the log storage file and the target time range. For example, a file identification list of the log storage file may be acquired, and the log storage file corresponding to the file identification in the file identification list that matches the target time range is determined as the target log storage file. There may be multiple manners of acquiring the file identification list. For example, the file identification list may be acquired by directly enumerating according to the first time granularity identification in the file name of the log storage file; for another example, an index may be established for the file identification list in each first time granularity, and the file identification list may be quickly determined according to the index of the file identification list. In addition, after the file identification list is acquired for the first time, the result may be cached to reduce the pressure on the storage system to list files.

After determining the target log storage file within the target time range, the target time index file corresponding to each of these target log storage files may be determined according to the one-to-one correspondence between the log storage file and the time index file, and then the time indexes in these target time index files may be acquired. After acquiring the time indexes in these target time index files, these time indexes may be cached to accelerate the acquisition process of the time indexes, while reducing the pressure on the storage system. In addition, in addition to determining the target time index file according to the target log storage file, the target time index file within the target time range may also be directly determined according to a matching between the identification of the time index file and the target time range, and the determination manner thereof is similar to the manner of determining the target log storage file according to the file identification as described above.

After acquiring the time indexes in the target time index file, these time indexes may be traversed, and the time index whose time identification matches the target time range is determined as the target time index according to the time identification of the time index.

After determining the target time index, the target query range corresponding to the target time index may be searched for from the target log storage file. For example, the target query range is determined according to the information of the storage address in the target time index.

However, since the storage addresses corresponding to the respective target time indexes may overlap with each other or be adjacent, after determining the target time index, before searching for the target query range corresponding to the target time index from the target log storage file, the target time indexes may be merged, that is, if the interval between the storage addresses corresponding to the two target time indexes is less than the preset merge length threshold, the two target time indexes are merged into one target time index, and then the target query range corresponding to the merged target time index is searched for from the target log storage file. In this way, log data within the target query range may be acquired from the storage system through a small number of IOPS, reducing the pressure on the storage system.

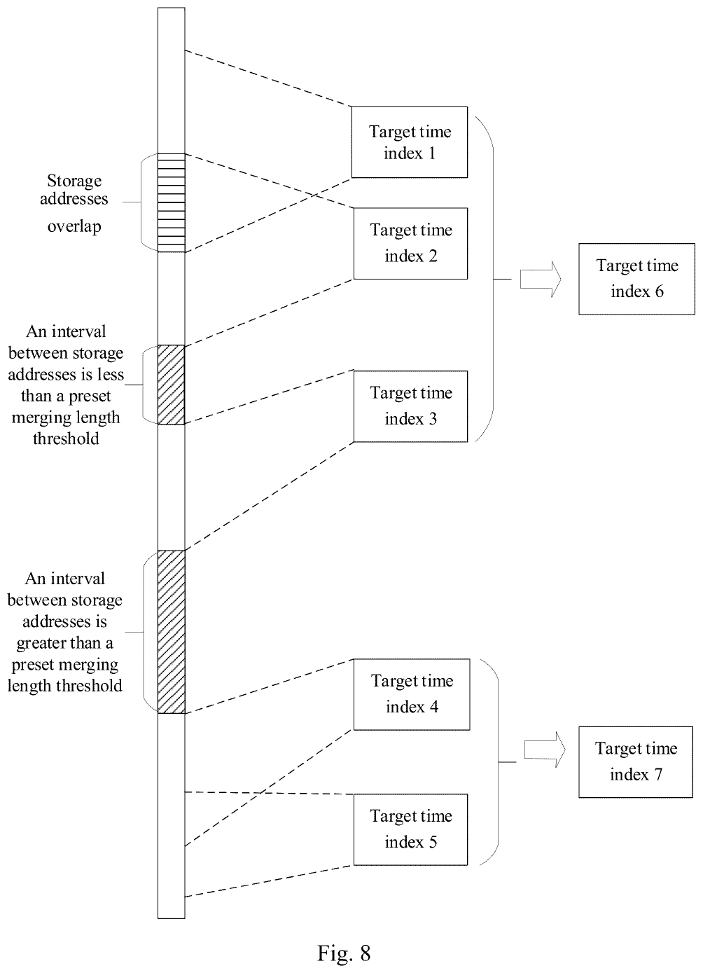

FIG. 8 is a schematic diagram of merging a target time index according to an embodiment of the present disclosure. The vertical rectangle in FIG. 8 is used to represent the storage address corresponding to the target time index. As shown in FIG. 8, since the storage address indicated by the target time index 1 overlaps with the storage address indicated by the target time index 2, and the interval between the storage address indicated by the target time index 2 and the storage address indicated by the target time index 3 is less than the preset merge length threshold, the target time index 1, the target time index 2, and the target time index 3 are merged into one target time index 6. Since the storage address indicated by the target time index 4 overlaps with the storage address indicated by the target time index 5, the target time index 4 and the target time index 5 are merged into one target time index 7.

For the preset merge length threshold, dynamic adjustment may be performed according to the target time range in the log query request.

In step S73, a query plan is constructed according to the target query range, where the query plan is used to indicate a query sub-task corresponding to a data block into which the target query range is divided.

Exemplarily, the query plan is constructed according to the target query range, which may be implemented in the following manner.

Firstly, the number of data blocks to be accessed is determined according to the target query range. Through the target time index, several relatively large target query ranges can usually be acquired. If all these target query ranges are scanned serially, the time-consuming of the log query may be relatively long, and the user experience is relatively poor. Therefore, the target query range may be divided into a plurality of data blocks firstly. The size of the data block is configurable, and may be, for example, 100 MB. There may be multiple data block division schemes. For example, the size of the data block may be determined according to factors such as the size of the target time range and the size of the total amount of data within the target query range.

Then, a plurality of the query sub-tasks are generated according to the number of the data blocks and the number of worker nodes in an idle state, where each query sub-task is used to request to access a specified data block; and then, the query plan is generated according to the plurality of the query sub-tasks.

In addition to considering the speed of the log query, the formulation of the query plan also needs to consider the fairness of log query requests and other issues, so as to avoid a single log query request occupying too many resources and affecting the execution of other log query requests. The query plan may be flexibly adjusted according to actual requirements. For example, if the log query can only be executed in a single node and a single process, the speed of the log query may be increased by means of multi-threaded concurrency between data blocks. Next, the generation of the query plan is described by taking a distributed system as an example.

Assuming that the distributed system has N worker nodes, a single log query request generates L data blocks, and a single query sub-task occupies at most P idle worker nodes, the distributed system may query the state of each worker node to determine whether there is an idle worker node. If there is an idle worker node, the data block is directly assigned to the idle worker node, and the assigned worker node is responsible for the actual log query process and returns the log query result. The range of the number of worker nodes that can be occupied by a single log query request is [1, min(P, L)], and the data block that has not been assigned a worker node waits until there is an idle worker node or the log query request times out and is cancelled. The worker node may be a process, a thread, or a coroutine, which may be implemented according to actual conditions. Through parallel execution, data blocks may be queried in parallel according to a certain degree of concurrency, so as to speed up the log query. In addition, in addition to considering the idle state of the worker node, the generation of the query plan may also consider factors such as a central processing unit and a memory of a physical node where the worker node is located. In addition, the previously described query plan is scheduled immediately as long as one worker node is idle. In practical applications, the scheduling may also be performed after waiting for a certain number of worker nodes to be idle.

In step S74, according to the query plan, a worker node is controlled to search in parallel for a data segment index matching with a data block specified by the assigned query sub-task from the data segment index file corresponding to the target log storage file, and the target log content is queried based on a target data block corresponding to the data segment index, where the data segment index file is dynamically constructed based on a data segment into which the log in the log storage file is divided.

Exemplarily, when searching for the data segment index, the data segment index file corresponding to the target log storage file may be searched for according to the correspondence between the log storage file and the data segment index file, then the target data segment index file matching with the target log content requested by the log query request is searched for from these data segment index files, and then the data segment index matching with the data block specified by the assigned query sub-task is searched for from the target data segment index file.

For example, for each data block, when loading the data segment index file that corresponds to the target log storage file corresponding to the data block, only the target data segment index file matching with the target log content requested by the log query request needs to be loaded. For example, the file identification of the target log storage file to which the data block belongs is 1, the target log content requested by the log query request is “score:80 AND name:xiaoming”, and the target time range requested by the log query request is from 10:00 to 11:00 on Jun. 18, 2024. Then, only the target data segment index file with the following identification needs to be loaded, that is, “the first time granularity identification matching with the target time range+the file identification of the target log storage file+the key identification matching with the target log content”, for example, only the data segment index file whose file name contains “score-2024061810-1” and “name-2024061810-1” needs to be loaded, while other data segment index files corresponding to the target log storage file do not need to be loaded. After finding the target data segment index file, the data segment index matching with the data block specified by the assigned query sub-task may be searched for from the target data segment index file. For example, if the storage address corresponding to the data segment index 1 in the target data segment index file overlaps with the storage address of the data block specified by the assigned query sub-task, it is determined that the data segment index 1 is the data segment index matching with the data block specified by the assigned query sub-task. Then, by matching the data segment index matching with the data block specified by the assigned query sub-task with the target log content requested by the log query request, it is possible to estimate in advance whether the data block specified by the query sub-task may contain data matching with the target log content requested by the log query request, that is, the data block can be filtered. For example, the information such as the maximum value, the minimum value, the bloom filter, the shared prefix tree, and the shared suffix tree in the data segment index is matched with the target log content requested by the log query request. If there is no match, the corresponding data block is filtered out and the subsequent data loading, parsing, filtering, and other processes are no longer required, thereby reducing the pressure on the storage system and improving the efficiency of the log query.

Exemplarily, the target log content is queried based on the target data block corresponding to the data segment index, which may comprise: before loading log data each time, determining an amount of log data loaded current time, where the amount of log data loaded current time is a minimum value of an expected storage read traffic (BestIoSize) and an amount of data that has not been loaded in the target data block; and loading the log data according to the amount of log data loaded current time. The target data block here refers to the data block finally obtained through the previously described data block filtering process. By controlling the amount of data loaded in a single time, problems such as memory exhaustion triggered by loading too much log data in a single time can be avoided. The size of the expected storage read traffic is configurable, for example, 4 MB.

In addition, since the data block generally comprises a header part and a data part, and the header part may further comprise some related metadata information, when loading the target data block, in addition to the above loading method, the header part may be loaded firstly, and metadata matching and filtering is performed, and then the data part is loaded.

In addition, since the original data in the data block is usually data after serialization and compression processing to reduce the storage cost and improve the transmission efficiency, for example, the serialization processing is performed through a serialization technology such as Protocol Buffers, and then the compression is performed through a compression algorithm (for example, lz4), the loaded log data generally needs to perform decompression, deserialization, and other processes, and then can match and filter with the target log content requested by the log query request log by log. If the queried log satisfies the target log content, it is added to the query result set. For example, if the target log content requested by the log query request is “score:80”, the log needs to be parsed one by one, and then the log is traversed to find whether there is log data with a key “score” and a value “80” in the log, and if there is, the log is added to the query result set. In addition, various matching and filtering schemes may be adopted for the matching and filtering. For example, when the storage system supports the capability of operator push-down, the filtering operation may be pushed down to the storage side for execution, thereby reducing a large amount of transmission overheads.

Further, in the log query process, it may be impossible to query a limited number of logs that satisfy the target log content within the timeout period. Therefore, in the log query process, the remaining available query time may be detected, and if the remaining available query time is less than or equal to a preset reserved time value (ReservedTime), the current log query result and the current log query progress (for example, offset information relative to the start position of the target log storage file, etc.) are returned. The size of ReservedTime is configurable, for example, 500 ms. That is, the concept of reserved time is introduced in the present disclosure, and the reserved time period is used to complete the processing of the log query result, the return of the log query result, and other processes, so as to avoid a log query failure on the client side due to timeout. The user may subsequently reissue the log query request carrying the log query progress to obtain more log data, so as to avoid a large number of timeout errors and improve the log query experience.

For timeout processing, in addition to the solution of the reserved time, a solution of setting a relatively long timeout period may also be used. For example, if the query client hopes to obtain a complete log query result through one log query, a relatively long timeout period may be set to avoid a large number of timeout errors.

By adopting the above technical solutions, the index used in the log query process comprises the time index file and the data segment index file. Since the time index file indexes the log storage file in time periods from the time dimension, and the data segment index file indexes the log storage file in data segments from the data segment dimension, there is no need to index by individual words in the log content and document IDs of the words as in the related art. Therefore, the storage cost of the log index is greatly reduced. In addition, in the log query process, the log query may be performed from the time dimension and the data segment dimension in combination with the time index file and the data segment index file, respectively, where the target query range within the target time range requested by the log query request may be determined through the time index file, and then the target query range may be further narrowed through the data segment index file, thereby speeding up the log query process, improving the performance of the log query, and satisfying more usage scenarios of the log query.

In some embodiments, the log query method according to the embodiments of the present disclosure may further comprise: before the log is written into the log storage file, classifying the log and writing the log into a corresponding log storage file according to a classification result, where different types of logs correspond to log storage files in different log sets (LogSet); and/or, before the log is written into the log storage file, parsing the log to obtain a plurality of key-value pairs, and then writing the log including the plurality of key-value pairs into the log storage file.

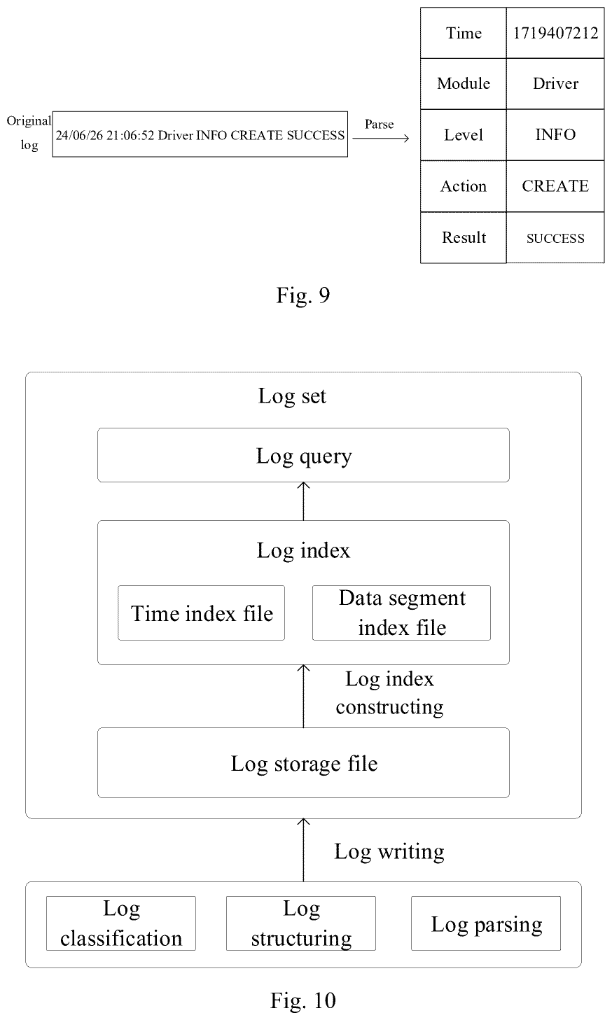

The generation mode of the log may be planned in advance, so that various application programs generate structured log data, which is convenient for parsing and processing the log data, for example, the generated log is in a JSON, delimiter, or other mode. Before the log data is written into the log storage file, the original structured log data may be parsed, and after the parsing, each log comprises a plurality of key-value pairs, and then the log including the plurality of key-value pairs is written into the log storage file, which is convenient for the log search engine to process data more efficiently. The parsing processing of the log may be completed by an application program or a log collector (LogAgent). An example of parsing a structured log is shown in FIG. 9, where the structured original log “24/06/26 21:06:52 Driver INFO CREATE SUCCESS” is parsed into 5 key-value pairs.

The log set is the smallest unit for log writing, consumption, and query. By writing logs of different log types into different log sets, isolation of different types of log data can be achieved, and the problem of read amplification in the log query process can be avoided. For example, there are two types of logs, type 1 and type 2. If both are written into the same log set, then in the query and scanning phase of the log data of type 1, it is possible to query and scan the log data of type 2, resulting in additional read overhead and low log query efficiency. These problems are solved by writing logs of different log types into different log sets.

Through the three aspects of log classification, log structuring, and log parsing, each log finally written into the log set comprises a plurality of parsed key-value pairs, which facilitates the log search engine to process the log more efficiently.

In addition, when writing the logs of different log types into different log sets, the identification item for identifying the log storage file, the time index file, and the data segment index file described above may further comprise a log set identification of the log set. Through the log set identification, it can be determined which log set the log storage file, the time index file, the data segment index file, etc. belong to.

FIG. 10 is a schematic diagram of an overall architecture of log query according to an embodiment of the present disclosure. As shown in FIG. 10, the overall architecture comprises three parts. The first part is log generation and collection, including log classification, log structuring, and log parsing; the second part is log index generation, including time index file generation and data segment index file generation; and the third part is log query. The specific implementations of these three parts have been described in detail above, and will not be repeated here.

The query performance evaluation of the log query method according to the present disclosure is exemplified below.

The present disclosure mainly accelerates the log query process by means of data block concurrency, metadata filtering, and other manners on the basis of a low-cost log index. Assuming that there are 100 million logs, and each log has a size of 1 KB, the total size of the original text of the 100 million logs is about 100 GB. The present disclosure divides the 100 GB data into 1024 data blocks of 100 MB, and the log query is performed between the data blocks with a maximum concurrency of 100. In the log query process, the size of each read traffic is 4 MB, the average time-consuming of each read is estimated to be 50 ms, and the time-consuming of parsing and filtering is estimated to be 30 ms. Then, without any metadata filtering, the scanning of the 100 million pieces of log data may be completed in about 20 seconds through the data block concurrency; through the metadata filtering, some data segments that cannot exist may be filtered out, thereby further accelerating the log query process. For example, for each data block, ¾ of the data is filtered out through the metadata, and does not need to be loaded, parsed, and filtered, and it takes at most about 5 seconds to complete the log query on a scale of 100 million pieces of data, which can meet most of the log query requirements.

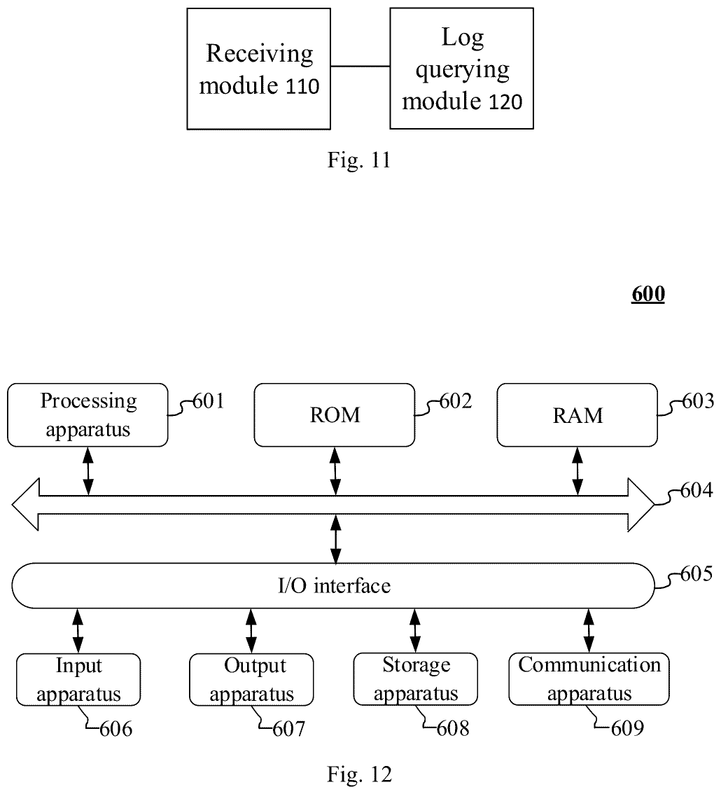

FIG. 11 is a schematic block diagram of a log query apparatus according to an embodiment of the present disclosure. The log query apparatus can be applied to various log query scenarios. As shown in FIG. 11, the log query apparatus may comprise: a receiving module 110, configured to receive a log query request, where the log query request is used to request to query target log content within a target time range; and a log query module 120, configured to, in response to the log query request, search for a target time index in a target time index file corresponding to the target time range and a target log storage file from a time index file constructed based on a log and a log storage file, respectively, and search for a target query range corresponding to the target time index from the target log storage file, where the time index file is dynamically constructed based on time in the log and is in a one-to-one correspondence with the log storage file; construct a query plan according to the target query range, where the query plan is used to indicate a query sub-task corresponding to a data block into which the target query range is divided; and control a worker node to search for, in parallel according to the query plan, a data segment index matching with a data block specified by an assigned query sub-task from a data segment index file corresponding to the target log storage file, and query the target log content based on a target data block corresponding to the data segment index, where the data segment index file is dynamically constructed based on a data segment obtained by dividing the log in the log storage file.

By adopting the above technical solutions, the index used in the log query process comprises the time index file and the data segment index file. Since the time index file indexes the log storage file in time periods from the time dimension, and the data segment index file indexes the log storage file in data segments from the data segment dimension, there is no need to index by individual words in the log content and document IDs of the words as in the related art. Therefore, the storage cost of the log index is greatly reduced. In addition, in the log query process, the log query may be performed from the time dimension and the data segment dimension in combination with the time index file and the data segment index file, respectively, where the target query range within the target time range requested by the log query request may be determined through the time index file, and then the target query range may be further narrowed through the data segment index file, thereby speeding up the log query process, improving the performance of the log query, and satisfying more usage scenarios of the log query.

Optionally, the log query apparatus further comprises a time index generation module (not shown), which is configured to: acquire a log of a time granularity from the log storage file and parse to obtain a time and a storage address of the log of the time granularity according to a preset time granularity of a time index; and generate the time index according to information of the storage address of the log of the time granularity and a time identification of the log of the time granularity determined based on the time granularity, and write the time index into the time index file in turn, where the time index is in a one-to-one correspondence with the log of the time granularity; and the time index file is in a one-to-one correspondence with the log storage file.

Optionally, the time index generation module is further configured to: if time identifications of two generated time indexes are the same and an interval between log storage addresses corresponding to the two time indexes is less than a preset merge length threshold, merge the two time indexes into one time index and update the one time index to the time index file.

Optionally, the log query apparatus further comprises a data segment index generation module (not shown), which is configured to: acquire a log from the log storage file and divide the log into a plurality of data segments according to a preset data segment division granularity, where each data segment comprises a plurality of logs; parse the data segment to obtain a key-value pair and a log storage address of each log in the data segment for each data segment; and generate one data segment index for a key of each log in the data segment for each data segment, and write the data segment index into the data segment index file in the order of generation, where the data segment index at least indicates a position of the corresponding data segment in the log storage file.

Optionally, the data segment index generation module is further configured to: when an amount of data in adjacent data segments is less than a preset data segment merge threshold, aggregate data segment indexes corresponding to the adjacent data segments into one data segment index and update it into the data index file.

Optionally, data segment indexes of different keys are stored and managed in different data segment index files.

Optionally, the log query module constructs the query plan according to the target query range, which comprises: determining the number of data blocks to be accessed according to the target query range; generating a plurality of the query sub-tasks according to the number of the data blocks and the number of worker nodes in an idle state, where each query sub-task is used to request to access a specified data block; and generating the query plan according to the plurality of the query sub-tasks.

Optionally, the log query module queries the target log content based on the target data block corresponding to the data segment index, which comprises: before loading log data each time, determining an amount of log data loaded current time, where the amount of log data loaded current time is a minimum value of an expected storage read traffic and an amount of data that has not been loaded in the target data block; and loading the log data according to the amount of log data loaded current time.

Optionally, the log query module is further configured to: detect remaining available query time in the query process; and in response that the remaining available query time is less than or equal to a preset reserved time value, return a current log query result and current log query progress.

Optionally, the log query apparatus further comprises a log storage file generation module (not shown), which is configured to: before the log is written into the log storage file, classify the log and write the log into a corresponding log storage file according to a classification result, where different types of logs correspond to log storage files in different log sets; and/or, before the log is written into the log storage file, parse the log to obtain a plurality of key-value pairs, and then write the log including the plurality of key-value pairs into the log storage file.

Optionally, the file name of the time index file comprises a log set identification, a log time, and a unique identification of a log storage file belonging to the log time in a corresponding log set.

The specific implementations of operations performed by respective modules in the log query apparatus according to the embodiments of the present disclosure have been described in detail in the related log query method, and will not be repeated here.

The present disclosure further provides a computer-readable medium, on which a computer program is stored, where the computer program, when executed by a processor, implements the steps of the method according to any one of the present disclosure.

The present disclosure further provides an electronic device, including:
a memory, on which a computer program is stored;
a processor, configured to execute the computer program in the memory to implement the steps of the method according to any one of the present disclosure.

The present disclosure further provides a computer program product, including a computer program, where the computer program, when executed by a processor, implements the steps of the method according to any one of the present disclosure.

Next, referring to FIG. 12, which illustrates a schematic structural diagram of an electronic device 600 suitable for implementing the embodiments of the present disclosure. The terminal device in the embodiments of the present disclosure may comprise, but is not limited to, a mobile terminal such as a mobile phone, a laptop, a digital broadcast receiver, a personal digital assistant (PDA), a tablet computer, a portable multimedia player (PMP), a vehicle-mounted terminal (such as a vehicle navigation terminal), and a fixed terminal such as a digital TV, a desktop computer, and the like. The electronic device shown in FIG. 12 is merely an example, and should not impose any limitation on the function and scope of use of the embodiments of the present disclosure.

As shown in FIG. 12, the electronic device 600 may comprise a processor 601 (such as a central processing unit, a graphics processor, etc.), which may perform various suitable actions and processing according to a program stored in a read-only memory (ROM) 602 or a program loaded from a memory 608 into a random access memory (RAM) 603. The RAM 603 further stores various programs and data required for the operation of the electronic device 600. The processor 601, the ROM 602, and the RAM 603 are connected to each other through a bus 604. An input/output (I/O) interface 605 is also connected to the bus 604.

Generally, the following apparatuses may be connected to the I/O interface 605: an input apparatus 606 such as a touchscreen, a touchpad, a keyboard, a mouse, a camera, a microphone, an accelerometer, a gyroscope, and the like; an output apparatus 607 such as a liquid crystal display (LCD), a speaker, a vibrator, and the like; a memory 608 such as a magnetic tape, a hard disk, and the like; and a communication apparatus 609. The communication apparatus 609 may allow the electronic device 600 to be in wireless or wired communication with other devices to exchange data. While FIG. 12 shows the electronic device 600 having various apparatuses, it should be understood that not all of the illustrated apparatuses are required to be implemented or provided. Alternatively, more or fewer apparatuses may be implemented or provided.

In particular, according to an embodiment of the present disclosure, the processes described above with reference to the flowcharts may be implemented as a computer software program. For example, an embodiment of the present disclosure comprises a computer program product, which comprises a computer program carried on a non-transitory computer-readable medium, and the computer program comprises program codes for executing the method shown in the flowchart. In such an embodiment, the computer program may be downloaded and installed from the network through the communication apparatus 609, or may be installed from the memory 608, or may be installed from the ROM 602. When the computer program is executed by the processor 601, the above functions defined in the methods of the embodiments of the present disclosure are executed.

It should be noted that the above computer-readable medium in the present disclosure may be a computer-readable signal medium or a computer-readable storage medium or any combination thereof. The computer-readable storage medium may be, for example, but not limited to, an electrical, magnetic, optical, electromagnetic, infrared, or semiconductor system, apparatus, or device, or any combination thereof. More specific examples of the computer-readable storage medium may comprise, but are not limited to, an electrical connection with one or more wires, a portable computer magnetic disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any appropriate combination thereof. In the present disclosure, the computer-readable storage medium may be any tangible medium that contains or stores a program that can be used by or in combination with an instruction execution system, apparatus, or device. In the present disclosure, the computer-readable signal medium may comprise a data signal that propagates in a baseband or as a part of a carrier, and carries computer-readable program codes. The data signal propagating in such a manner may be in various forms, including but not limited to an electromagnetic signal, an optical signal, or any appropriate combination thereof. The computer-readable signal medium may also be any computer-readable medium other than the computer-readable storage medium, and the computer-readable signal medium may send, propagate, or transmit a program used by or in combination with an instruction execution system, apparatus, or device. The program codes contained on the computer-readable medium may be transmitted by any suitable medium, including but not limited to a wire, an optical cable, a radio frequency (RF), or any appropriate combination thereof.

In some implementations, clients and servers may communicate using any currently known or future developed network protocol, such as the HyperText Transfer Protocol (HTTP), and may be interconnected with any form or medium of digital data communication (for example, a communication network). Examples of communication networks comprise a local area network (“LAN”), a wide area network (“WAN”), an internetwork (for example, the Internet), and a peer-to-peer network (for example, an ad hoc network), as well as any currently known or future developed network.

The above computer-readable medium may be comprised in the above electronic device; or may exist alone without being assembled into the electronic device.

The computer-readable medium carries one or more programs, and when the one or more programs are executed by the electronic device, the electronic device is caused to: receive a log query request, where the log query request is used to request to query target log content within a target time range; in response to the log query request, search for a target time index in a target time index file corresponding to the target time range and a target log storage file from a time index file constructed based on a log and a log storage file, respectively, and search for a target query range corresponding to the target time index from the target log storage file, where the time index file is dynamically constructed based on time in the log and is in a one-to-one correspondence with the log storage file; construct a query plan according to the target query range, where the query plan is used to indicate a query sub-task corresponding to a data block into which the target query range is divided; and according to the query plan, control a worker node to search in parallel for a data segment index matching with a data block specified by an assigned query sub-task from a data segment index file corresponding to the target log storage file, and query the target log content based on a target data block corresponding to the data segment index, where the data segment index file is dynamically constructed based on a data segment into which the log in the log storage file is divided.

The computer program codes for performing the operations of the present disclosure may be written in one or more programming languages or a combination thereof, where the above programming languages comprise but are not limited to object-oriented programming languages such as Java, Smalltalk, C++, and further comprise conventional procedural programming languages such as C or similar programming languages. The program codes may be executed entirely on a user's computer, partly on the user's computer, as a stand-alone software package, partly on the user's computer and partly on a remote computer, or entirely on the remote computer or server. In the scenario involving the remote computer, the remote computer may be connected to the user's computer through any type of network, including a local area network (LAN) or a wide area network (WAN), or the connection may be made to an external computer (for example, through the Internet using an Internet service provider).

The flowcharts and block diagrams in the drawings illustrate the architecture, functionality, and operation of possible implementations of systems, methods and computer program products according to various embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may occur out of the order noted in the drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a special purpose hardware-based system that performs the specified functions or operations, or may also be implemented by a combination of special purpose hardware and computer instructions.

The modules involved in the embodiments of the present disclosure may be implemented in software or hardware. The name of the module does not constitute a limitation of the module itself under certain circumstances. For example, the receiving module may also be described as “a module for receiving a log query request”.

The functions described herein above may be performed, at least partially, by one or more hardware logic components. For example, without limitation, available exemplary types of hardware logic components comprise: a field programmable gate array (FPGA), an application specific integrated circuit (ASIC), an application specific standard product (ASSP), a system on chip (SOC), a complex programmable logical device (CPLD), and the like.

In the context of the present disclosure, a machine-readable medium may be a tangible medium that may contain or store a program for use by or in combination with an instruction execution system, apparatus, or device. The machine-readable medium may be a machine-readable signal medium or a machine-readable storage medium. The machine-readable medium may comprise, but is not limited to, an electronic, magnetic, optical, electromagnetic, infrared, or semiconductor system, apparatus, or device, or any suitable combination thereof. More specific examples of the machine-readable storage medium may comprise an electrical connection based on one or more wires, a portable computer disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof.

According to one or more embodiments of the present disclosure, Example 1 provides a log query method, including: receiving a log query request, where the log query request is used to request to query target log content within a target time range; in response to the log query request, searching for a target time index in a target time index file corresponding to the target time range and a target log storage file from a time index file constructed based on a log and a log storage file, respectively, and searching for a target query range corresponding to the target time index from the target log storage file, where the time index file is dynamically constructed based on time in the log and is in a one-to-one correspondence with the log storage file; constructing a query plan according to the target query range, where the query plan is used to indicate a query sub-task corresponding to a data block into which the target query range is divided; and according to the query plan, controlling a worker node to search in parallel for a data segment index matching with a data block specified by an assigned query sub-task from a data segment index file corresponding to the target log storage file, and querying the target log content based on a target data block corresponding to the data segment index, where the data segment index file is dynamically constructed based on a data segment into which the log in the log storage file is divided.

According to one or more embodiments of the present disclosure, Example 2 provides the method of Example 1, where the method further comprises: acquiring a log of a time granularity from the log storage file and parsing to obtain a time and a storage address of the log of the time granularity according to a preset time granularity of a time index; and generating the time index according to information of the storage address of the log of the time granularity and a time identification of the log of the time granularity determined based on the time granularity, and writing the time index into the time index file in turn, where the time index is in a one-to-one correspondence with the log of the time granularity; and the time index file is in a one-to-one correspondence with the log storage file.

According to one or more embodiments of the present disclosure, Example 3 provides the method of Example 2, where the method further comprises: in response that time identifications of two generated time indexes are the same and an interval between log storage addresses corresponding to the two time indexes is less than a preset merge length threshold, merging the two time indexes into one time index and updating the one time index into the time index file.

According to one or more embodiments of the present disclosure, Example 4 provides the method of Example 1, where the method further comprises: acquiring a log from the log storage file and dividing the log into a plurality of data segments according to a preset data segment division granularity, where each data segment comprises a plurality of logs; for each data segment, parsing the data segment to obtain a key-value pair and a log storage address of each log; and for each data segment, generating one data segment index for a key of each log in the data segment, and writing the data segment index into the data segment index file in the order of generation, where the data segment index at least indicates a position of the corresponding data segment in the log storage file.

According to one or more embodiments of the present disclosure, Example 5 provides the method of Example 4, where the method further comprises: when an amount of data in an adjacent data segment is less than a preset data segment merge threshold, aggregating data segment indexes corresponding to the adjacent data segment into one data segment index and updating the data index file.

According to one or more embodiments of the present disclosure, Example 6 provides the method of Example 4, where data segment indexes of different keys are stored and managed in different data segment index files.

According to one or more embodiments of the present disclosure, Example 7 provides the method of Example 1, where the constructing the query plan according to the target query range comprises: determining the number of data blocks to be accessed according to the target query range; generating a plurality of the query sub-tasks according to the number of the data blocks and the number of worker nodes in an idle state, where each query sub-task is used to request to access a specified data block; and generating the query plan according to the plurality of the query sub-tasks.

According to one or more embodiments of the present disclosure, Example 8 provides the method of Example 1, where the querying the target log content based on a target data block corresponding to the data segment index comprises: before loading log data each time, determining an amount of log data loaded current time, where the amount of log data loaded current time is a minimum value of an expected value of storage read traffic and an amount of data that has not been loaded in the target data block; and loading the log data according to the amount of log data loaded current time.

According to one or more embodiments of the present disclosure, Example 9 provides the method of any one of Examples 1 to 8, where the method further comprises: detecting remaining available query time in a query process; and if the remaining available query time is less than or equal to a preset reserved time value, returning a current log query result and current log query progress.

According to one or more embodiments of the present disclosure, Example 10 provides the method of any one of Examples 1 to 8, where the method further comprises: before a log is written into the log storage file, classifying the log and writing the log into a corresponding log storage file according to a classification result, where different types of logs correspond to log storage files in different log sets; and/or, before the log is written into the log storage file, parsing the log to obtain a plurality of key-value pairs, and then writing the log including the plurality of key-value pairs into the log storage file.

According to one or more embodiments of the present disclosure, Example 11 provides the method of any one of Examples 1 to 8, where a file name of the time index file comprises a log set identification, a log time, and a unique identification of a log storage file belonging to the log time in a corresponding log set.

According to one or more embodiments of the present disclosure, Example 12 provides a log query apparatus, including: a receiving module, configured to receive a log query request, where the log query request is used to request to query target log content within a target time range; and a log query module, configured to, in response to the log query request, search for a target time index in a target time index file corresponding to the target time range and a target log storage file from a time index file constructed based on a log and a log storage file, respectively, and search for a target query range corresponding to the target time index from the target log storage file, where the time index file is dynamically constructed based on time in the log and is in a one-to-one correspondence with the log storage file; construct a query plan according to the target query range, where the query plan is used to indicate a query sub-task corresponding to a data block into which the target query range is divided; and according to the query plan, control a worker node to search in parallel for a data segment index matching with a data block specified by an assigned query sub-task from a data segment index file corresponding to the target log storage file, and query the target log content based on a target data block corresponding to the data segment index, where the data segment index file is dynamically constructed based on a data segment into which the log in the log storage file is divided.

According to one or more embodiments of the present disclosure, Example 13 provides a computer-readable medium, on which a computer program is stored, where the computer program, when executed by a processor, implements the steps of the method according to any one of Examples 1 to 11.

According to one or more embodiments of the present disclosure, Example 14 provides an electronic device, including:
a memory, on which a computer program is stored;
a processor, configured to execute the computer program in the memory to implement the steps of the method according to any one of Examples 1 to 11.

According to one or more embodiments of the present disclosure, Example 15 provides a computer program product, including a computer program, where the computer program, when executed by a processor, implements the steps of the method according to any one of Examples 1 to 11.

The above descriptions are merely preferred embodiments of the present disclosure and illustrations of the applied technical principles. Those skilled in the art should understand that the scope of disclosure involved in the present disclosure is not limited to the technical solutions formed by the specific combination of the above technical features, and should also cover other technical solutions formed by any combination of the above technical features or equivalent features thereof without departing from the above disclosed concept, for example, a technical solution formed by replacing the above features with the technical features with similar functions disclosed in the present disclosure (but not limited thereto).

In addition, although operations are depicted in a particular order, it should not be understood that these operations are required to be performed in the specific order shown or in a sequential order. Under certain circumstances, multitasking and parallel processing may be advantageous. Similarly, although the above discussion contains several specific implementation details, these should not be interpreted as limitations on the scope of the present disclosure. Certain features that are described in the context of separate embodiments may also be implemented in combination in a single embodiment. Conversely, various features described in the context of a single embodiment may also be implemented in multiple embodiments individually or in any suitable sub-combination.

Although the subject matter has been described in language specific to structural features and/or logical actions of the method, it should be understood that the subject matter defined in the appended claims is not necessarily limited to the specific features or actions described above. Rather, the specific features and actions described above are merely example forms for implementing the claims. Regarding the apparatuses in the above embodiments, the specific manners in which the respective modules perform operations have been described in detail in the embodiments related to the method, and will not be described in detail here.

1. A method for log query, comprising:
receiving a log query request, wherein the log query request is used to request to query target log content within a target time range;
in response to the log query request, searching for a target time index in a target time index file corresponding to the target time range and a target log storage file from a time index file constructed based on a log and a log storage file, respectively, and searching for a target query range corresponding to the target time index from the target log storage file, wherein the time index file is dynamically constructed based on time in the log and is in a one-to-one correspondence with the log storage file;
constructing a query plan according to the target query range, wherein the query plan is used to indicate a query sub-task corresponding to a data block into which the target query range is divided; and
according to the query plan, controlling a worker node to search in parallel for a data segment index matching with a data block specified by an assigned query sub-task from a data segment index file corresponding to the target log storage file, and querying the target log content based on a target data block corresponding to the data segment index, wherein the data segment index file is dynamically constructed based on a data segment into which the log in the log storage file is divided.

2. The method according to claim 1, wherein the method further comprises:
acquiring a log of a time granularity from the log storage file and parsing to obtain a time and a storage address of the log of the time granularity, according to a preset time granularity of a time index; and
generating the time index according to information of the storage address of the log of the time granularity and a time identification of the log of the time granularity determined based on the time granularity, and writing the time index into the time index file in turn, wherein the time index is in a one-to-one correspondence with the log of the time granularity, and the time index file is in a one-to-one correspondence with the log storage file.

3. The method according to claim 2, wherein the method further comprises:
in response that time identifications of two time indexes generated are same and an interval between log storage addresses corresponding to the two time indexes is less than a preset merge length threshold, merging the two time indexes into one time index and updating the one time index into the time index file.

4. The method according to claim 1, wherein the method further comprises:
acquiring a log from the log storage file and dividing the log into a plurality of data segments according to a preset data segment division granularity, wherein each data segment comprises a plurality of logs;
for each data segment, parsing the data segment to obtain a key-value pair and a log storage address of each log; and
for each data segment, generating one data segment index for a key of each log in the data segment, and writing the data segment index into the data segment index file in an order of generation, wherein the data segment index at least indicates a position of a corresponding data segment in the log storage file.

5. The method according to claim 4, wherein the method further comprises:
when an amount of data in an adjacent data segment is less than a preset data segment merge threshold, aggregating data segment indexes corresponding to the adjacent data segment into one data segment index and updating the data index file.

6. The method according to claim 4, wherein data segment indexes of different keys are stored and managed in different data segment index files.

7. The method according to claim 1, wherein the constructing a query plan according to the target query range comprises:
determining a number of data blocks to be accessed according to the target query range;
generating a plurality of query sub-tasks according to the number of the data blocks and a number of worker nodes in an idle state, wherein each query sub-task is used to request to access a specified data block; and
generating the query plan according to the plurality of query sub-tasks.

8. The method according to claim 1, wherein the querying the target log content based on a target data block corresponding to the data segment index comprises:
before loading log data each time, determining an amount of log data loaded current time, wherein the amount of log data loaded current time is a minimum value of an expected value of storage read traffic and an amount of data that has not been loaded in the target data block; and
loading the log data according to the amount of log data loaded current time.

9. The method according to claim 1, wherein the method further comprises:
detecting remaining available query time in a query process; and
In response that the remaining available query time is less than or equal to a preset reserved time value, returning a current log query result and current log query progress.

10. The method according to claim 1, wherein the method further comprises:
before the log is written into the log storage file, classifying the log and writing the log into a corresponding log storage file according to a classification result, wherein different types of logs correspond to log storage files in different log sets; and/or,
before the log is written into the log storage file, parsing the log to obtain a plurality of key-value pairs, and then writing the log comprising the plurality of key-value pairs into the log storage file.

11. The method according to claim 1, wherein a file name of the time index file comprises a log set identification, a log time, and a unique identification of a log storage file belonging to the log time in a corresponding log set.

12. A non-transitory computer-readable medium, on which a computer program is stored, wherein the computer program, when executed by at least one processor, implements a log query method, which comprises:
receiving a log query request, wherein the log query request is used to request to query target log content within a target time range;
in response to the log query request, searching for a target time index in a target time index file corresponding to the target time range and a target log storage file from a time index file constructed based on a log and a log storage file, respectively, and searching for a target query range corresponding to the target time index from the target log storage file, wherein the time index file is dynamically constructed based on time in the log and is in a one-to-one correspondence with the log storage file;
constructing a query plan according to the target query range, wherein the query plan is used to indicate a query sub-task corresponding to a data block into which the target query range is divided; and
according to the query plan, controlling a worker node to search in parallel for a data segment index matching with a data block specified by an assigned query sub-task from a data segment index file corresponding to the target log storage file, and querying the target log content based on a target data block corresponding to the data segment index, wherein the data segment index file is dynamically constructed based on a data segment into which the log in the log storage file is divided.

13. An electronic device, comprising:
a memory, on which a computer program is stored;
at least one processor, configured to execute the computer program in the memory to implement a log query method, which comprises:
receiving a log query request, wherein the log query request is used to request to query target log content within a target time range;
in response to the log query request, searching for a target time index in a target time index file corresponding to the target time range and a target log storage file from a time index file constructed based on a log and a log storage file, respectively, and searching for a target query range corresponding to the target time index from the target log storage file, wherein the time index file is dynamically constructed based on time in the log and is in a one-to-one correspondence with the log storage file;
constructing a query plan according to the target query range, wherein the query plan is used to indicate a query sub-task corresponding to a data block into which the target query range is divided; and
according to the query plan, controlling a worker node to search in parallel for a data segment index matching with a data block specified by an assigned query sub-task from a data segment index file corresponding to the target log storage file, and querying the target log content based on a target data block corresponding to the data segment index, wherein the data segment index file is dynamically constructed based on a data segment into which the log in the log storage file is divided.

14. The electronic device according to claim 13, wherein the processor further implements:
acquiring a log of a time granularity from the log storage file and parsing to obtain a time and a storage address of the log of the time granularity, according to a preset time granularity of a time index; and
generating the time index according to information of the storage address of the log of the time granularity and a time identification of the log of the time granularity determined based on the time granularity, and writing the time index into the time index file in turn, wherein the time index is in a one-to-one correspondence with the log of the time granularity, and the time index file is in a one-to-one correspondence with the log storage file.

15. The electronic device according to claim 14, wherein the processor further implements:
in response that time identifications of two time indexes generated are same and an interval between log storage addresses corresponding to the two time indexes is less than a preset merge length threshold, merging the two time indexes into one time index and updating the one time index into the time index file.

16. The electronic device according to claim 13, wherein the processor further implements:
acquiring a log from the log storage file and dividing the log into a plurality of data segments according to a preset data segment division granularity, wherein each data segment comprises a plurality of logs;
for each data segment, parsing the data segment to obtain a key-value pair and a log storage address of each log; and
for each data segment, generating one data segment index for a key of each log in the data segment, and writing the data segment index into the data segment index file in an order of generation, wherein the data segment index at least indicates a position of a corresponding data segment in the log storage file.

17. The electronic device according to claim 16, wherein the processor further implements:
when an amount of data in an adjacent data segment is less than a preset data segment merge threshold, aggregating data segment indexes corresponding to the adjacent data segment into one data segment index and updating the data index file.

18. The electronic device according to claim 16, wherein data segment indexes of different keys are stored and managed in different data segment index files.

19. The electronic device according to claim 13, wherein the constructing the query plan according to the target query range comprises:
determining a number of data blocks to be accessed according to the target query range;
generating a plurality of query sub-tasks according to the number of the data blocks and a number of worker nodes in an idle state, wherein each query sub-task is used to request to access a specified data block; and
generating the query plan according to the plurality of query sub-tasks.

20. The electronic device according to claim 13, wherein the querying the target log content based on a target data block corresponding to the data segment index comprises:
before loading log data each time, determining an amount of log data loaded current time, wherein the amount of log data loaded current time is a minimum value of an expected value of storage read traffic and an amount of data that has not been loaded in the target data block; and
loading the log data according to the amount of log data loaded current time.
